(19) United States
(12) Patent Application Publication
(10) Pub. No.: US 2009/0260345 A1
(43) Pub. Date: Oct. 22, 2009

(54) FAN VARIABLE AREA NOZZLE WITH ADAPTIVE STRUCTURE

(76) Inventor: Zaffir Chaudhry, South Glastonbury, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/373,773

(22) PCT Filed: Oct. 12, 2006
(86) PCT No.: PCT/US06/39948

§ 371 Date: Jan. 14, 2009

(51) Int. Cl. F02K 3/02; F01D 1/02

(52) U.S. Cl. 60/226.3; 415/208.1

(57) ABSTRACT

A fan variable area nozzle (FVAN) includes a flexible adaptive segment which defines the fan nozzle exit area. The flexible adaptive segment generally includes a multiple of flexible sections, a linkage and an actuator system to morph the flexible adaptive segment between a converged shape and a diverged shape. The flexible adaptive segments seal an interface between sectors to provide an asymmetrical fan nozzle exit area.

### BACKGROUND OF THE INVENTION

The present invention relates to a gas turbine engine, and more particularly to a turbofan engine having an adaptive or morphing fan nacelle thereof.

Conventional gas turbine engines generally include a fan section and a core engine with the fan section having a larger diameter than that of the core engine. The fan section and the core engine are disposed about a longitudinal axis and are enclosed within an engine nacelle assembly.

Combustion gases are discharged from the core engine through a core exhaust nozzle while an annular fan flow, disposed radially outward of the primary airflow path, is discharged through an annular fan exhaust nozzle defined between a fan nacelle and a core nacelle. A majority of thrust is produced by the pressurized fan air discharged through the fan exhaust nozzle, the remaining thrust being provided from the combustion gases discharged through the core exhaust nozzle.

The fan nozzles of conventional gas turbine engines have a fixed geometry. The fixed geometry fan nozzles are a compromise suitable for take-off and landing conditions as well as for cruise conditions. Some gas turbine engines have implemented fan variable area nozzles. The fan variable area nozzle provide a smaller fan exit nozzle diameter during cruise conditions and a larger fan exit nozzle diameter during take-off and landing conditions. Existing fan variable area nozzles typically utilize relatively complex mechanisms that increase overall engine weight to the extent that the increased fuel efficiency therefrom may be negated.

Accordingly, it is desirable to provide an effective, lightweight fan variable area nozzle for a gas turbine engine.

### SUMMARY OF THE INVENTION

A fan variable area nozzle (FVAN) according to the present invention includes an adaptive segment which defines a variable fan nozzle exit area. The adaptive segment is incorporated adjacent an end segment of a fan nacelle to include a trailing edge thereof. The adaptive segment generally includes a multiple of flexible sections, a linkage and an actuator system to morph the adaptive segment between a converged shape and a diverged shape.

The FVAN is separated into a multiple of sectors which are each independently adjustable by an associated actuator of the actuator system. The adaptive segments advantageously provide a flexible sealed interface between the sectors to provide a low drag asymmetrical fan nozzle exit area and allows the shape of the FVAN to change in addition to the fan nozzle exit area.

The present invention therefore provides an effective, lightweight fan variable area nozzle for a gas turbine engine.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1A is a general schematic partial fragmentary view of an exemplary gas turbine engine embodiment for use with the present invention;

FIG. 1B is a perspective partial fragmentary view of the engine;

FIG. 1C is a rear view of the engine;

FIG. 2 is a sectional view through a section of the FVAN; and

FIG. 3 is a sectional view of another FVAN with a linear actuator.

### DETAILED DESCRIPTION OF THE PREFERRED EMBODIMENT

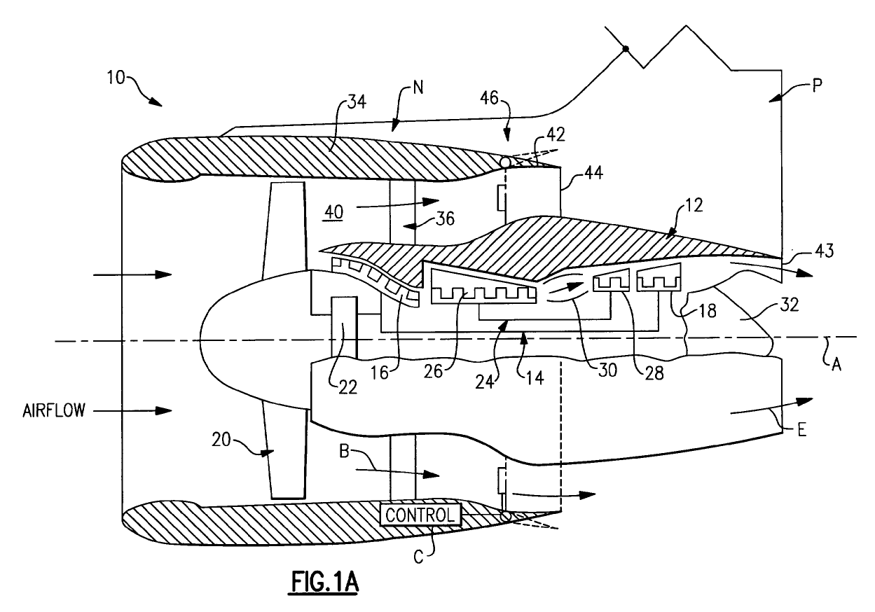

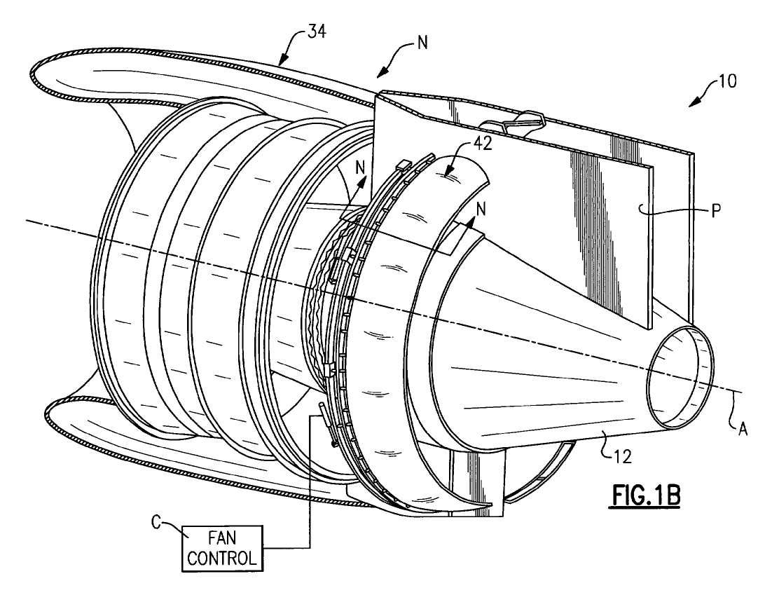

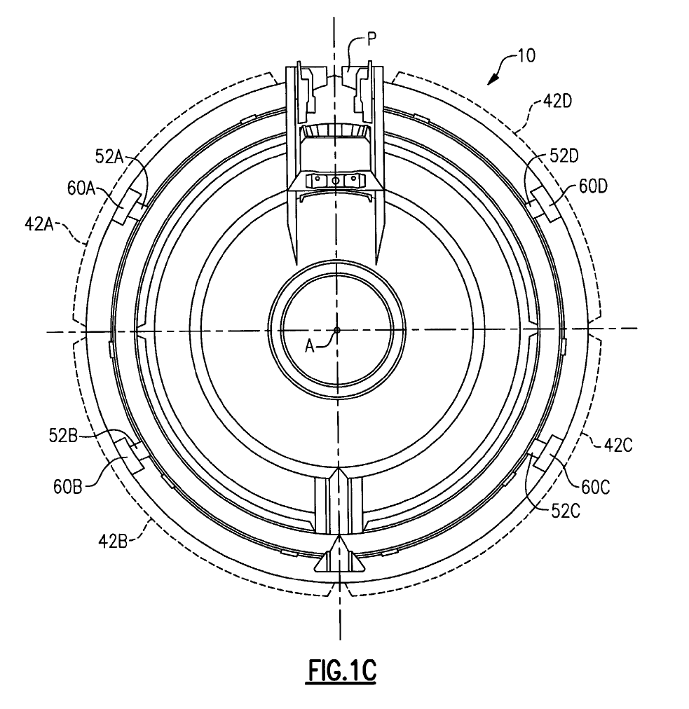

FIG. 1A illustrates a general partial fragmentary schematic view of a gas turbofan engine 10 suspended from an engine pylon P within an engine nacelle assembly N as is typical of an aircraft designed for subsonic operation.

The turbofan engine 10 includes a core engine within a core nacelle 12 that houses a low spool 14 and high spool 24. The low spool 14 includes a low pressure compressor 16 and low pressure turbine 18. The low spool 14 drives a turbofan 20 through a gear train 22. The high spool 24 includes a high pressure compressor 26 and high pressure turbine 28. A combustor 30 is arranged between the high pressure compressor 26 and high pressure turbine 28. The low and high spools 14, 24 rotate about an engine axis of rotation A.

The engine 10 is preferably a high-bypass geared turbofan aircraft engine. Preferably, the engine 10 bypass ratio is greater than ten (10), the turbofan diameter is significantly larger than that of the low pressure compressor 16, and the low pressure turbine 18 has a pressure ratio that is greater than 5. The gear train 22 is preferably an epicycle gear train such as a planetary gear system or other gear system with a gear reduction ratio of greater than 2.5. It should be understood, however, that the above parameters are only exemplary of a preferred geared turbofan engine and that the present invention is likewise applicable to other gas turbine engines.

Airflow enters a fan nacelle 34, which at least partially surrounds the core nacelle 12. The turbofan 20 communicates airflow into the core nacelle 12 to power the low pressure compressor 16 and the high pressure compressor 26. Core airflow compressed by the low pressure compressor 16 and the high pressure compressor 26 is mixed with the fuel in the combustor 30 and expanded over the high pressure turbine 28 and low pressure turbine 18. The turbines 28, 18 are coupled for rotation with, respective, spools 24, 14 to rotationally drive the compressors 26, 16 and through the gear train 22, the turbo fan 20 in response to the expansion. A core engine exhaust E exits the core nacelle 12 through a core nozzle 43 defined between the core nacelle 12 and a tail cone 32.

The core nacelle 12 is supported within the fan nacelle 34 by structure 36 often generically referred to as an upper and lower bifurcation. A bypass flow path 40 is defined between the core nacelle 12 and the fan nacelle 34. The engine 10 generates a high bypass flow arrangement with a bypass ratio in which approximately 80 percent of the airflow entering the fan nacelle 34 becomes bypass flow B. The bypass flow B communicates through the generally annular bypass flow path 40 and is discharged from the engine 10 through a fan variable area nozzle (FVAN) 42 (also illustrated in FIG. 1B) which defines a fan nozzle exit area 44 between the fan nacelle 34 and the core nacelle 12 at an end segment 46 of the fan nacelle 34.

Thrust is a function of density, velocity, and area. One or more of these parameters can be manipulated to vary the amount and direction of thrust provided by the bypass flow B. The FVAN 42 changes the physical area and geometry to manipulate the thrust provided by the bypass flow B. However, it should be understood that the nozzle exit area 44 may be effectively altered by methods other than structural changes, for example, by altering the boundary layer. Furthermore, it should be understood that effectively altering the nozzle exit area 44 is not limited to physical locations approximate the exit of the fan nacelle 34, but rather, may include the alteration of the bypass flow B at other locations.

The FVAN 42 defines the fan nozzle exit area 44 for discharging axially the fan bypass flow B pressurized by the upstream turbofan 20. A significant amount of thrust is provided by the bypass flow B due to the high bypass ratio. The turbofan 20 of the engine 10 is preferably designed for a particular flight condition—typically cruise at 0.8M and 35,000 feet. As the turbofan 20 is efficiently designed at a particular fixed incidence for the cruise condition, the FVAN 42 is operated to vary the fan nozzle exit area 44 for efficient engine operation at other flight conditions, such as landing and takeoff and to meet other operational parameters such as noise level. Preferably, the FVAN 42 defines a nominal converged cruise position for the fan nozzle exit area 44 and radially opens relative thereto to define a diverged position for other flight conditions. The FVAN 42 preferably provides an approximately 20% (twenty percent) change in the fan exit nozzle area 44. It should be understood that other arrangements as well as essentially infinite intermediate positions as well as thrust vectored positions in which some circumferential sectors of the FVAN 42 are converged or diverged relative to other circumferential sectors are likewise usable with the present invention.

In addition to the area change of the fan exit nozzle area 44, the flexible adaptive segment 48 permits the shape of the FVAN 42 itself to be changed. That is, the flexible adaptive segment 48 facilitates a shape change of the fan exit nozzle area 44 upstream of the trailing edge 34T, for example only, to a different thickness profile, or the like.

The FVAN 42 is preferably separated into four or more sectors 42A-42D (FIG. 1C) which are each independently adjustable to asymmetrically vary the fan nozzle exit area 44. It should be understood that although four segments are illustrated, any number of segments may alternatively or additionally be provided.

In operation, the FVAN 42 communicates with a controller C or the like to adjust the fan nozzle exit area 44. Other control systems including an engine controller flight control system may likewise be usable with the present invention. By adjusting the entire periphery of the FVAN 42 in which all sectors are moved uniformly, thrust efficiency and fuel economy are maximized during each flight condition. By separately adjusting the circumferential sectors 42A-42D of the FVAN 42 to provide an asymmetrical fan nozzle exit area 44, engine bypass flow is selectively vectored to provide, for example only, trim balance or thrust controlled maneuvering enhanced ground operations or short field performance.

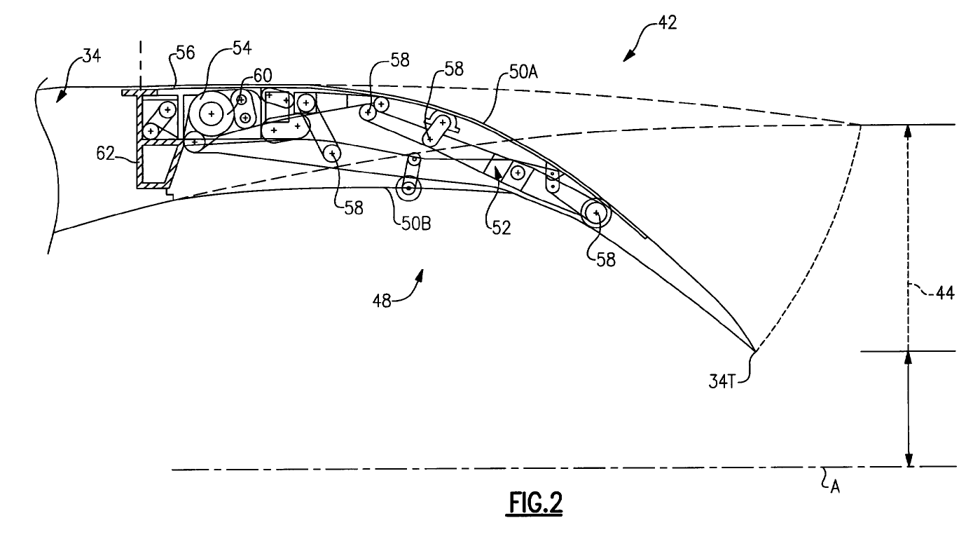

Referring to FIG. 2, the FVAN 42 generally includes a flexible adaptive segment 48 which varies the fan nozzle exit area 44. The flexible adaptive segment 48 is preferably incorporated into the end segment 46 of the fan nacelle 34 to include a trailing edge 34T thereof. The flexible adaptive segment 48 generally includes a multiple of flexible skins 50a, 50b, a linkage 52 and an actuator system 54.

The flexible skins 50a, 50b are preferably integrated into a skin section 56 of the fan nacelle 34. The flexible skins 50a, 50b are resilient members which permit the flexible adaptive segment 48 to change shape or morph between a converged shape and a diverged shape (shown in phantom). That is, the end segment 46 of the fan nacelle 34 essentially flexes without a discreet hinge line. Preferably, the failsafe shape is the diverged shape as the diverged shape is utilized for landing and takeoff. The flexible adaptive segment 48 also preferably provides a flexible sealed interface between the sectors 42A-42D (FIG. 1C).

The linkage 52 is driven by the actuator system 54 to change the shape of the flexible adaptive segment 48 between the converged shape and the diverged shape. The linkage 52 includes pivots 58 which include pivoting members such as bearings, bushings or flexures to achieve the desired shape change. Flexures may be preferred as flexures minimize hysteresis. It should be understood that the linkage 52 and pivots 58 are geometrically arranged to provide the desired FVAN 42 positions in response to the actuator system 54 position.

The actuator system 54 preferably includes a multitude of rotary actuators 60 mounted to a fixed component within the fan nacelle 34 such as spar 62 or the like. Each rotary actuator 60 rotates to drives the linkage 52 and change the shape of the flexible adaptive segment 48 between the converged shape and diverged shape.

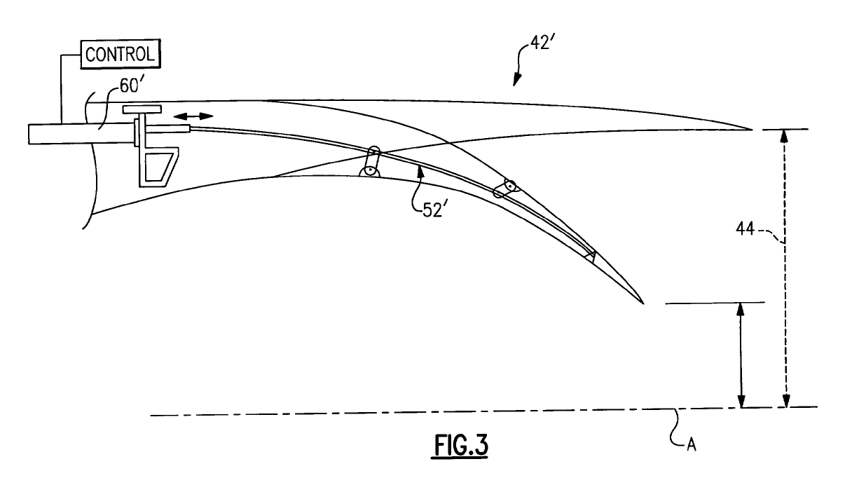

Referring to FIG. 3, another embodiment of the FVAN 42 includes a linear actuator 60′ mounted to a fixed component within the fan nacelle 34 such as the spar 62 or the like. Each linear actuator 60′ strokes to drive a linkage assembly 52′ to change the shape of the flexible adaptive segment 48 between the converged shape and the diverged shape (shown in phantom). It should be understood that other actuators and combinations thereof may also be utilized with the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A nacelle assembly for a gas turbine engine comprising:
a core nacelle defined about an axis; and
a fan nacelle mounted at least partially around said core nacelle, said fan nacelle having a fan variable area nozzle with a flexible adaptive segment which varies a fan exit area between said fan nacelle and said core nacelle.

2. The assembly as recited in claim 1, wherein said flexible adaptive segment flexes relative to said fan nacelle.

3. The assembly as recited in claim 1, wherein said flexible adaptive segment includes a trailing edge of said fan variable area nozzle.

4. The assembly as recited in claim 1, further comprising a rotary actuator which flexes said flexible adaptive segment.

5. The assembly as recited in claim 1, further comprising a linear actuator which flexes said flexible adaptive segment.

6. The assembly as recited in claim 1, wherein said flexible adaptive segment includes a flexible nacelle skin.

7. The assembly as recited in claim 6, further comprising a linkage within said fan nacelle to change a shape of said flexible adaptive segment in response to an actuator which drives said linkage.

8. The assembly as recited in claim 1, wherein said fan exit area defines an at least partially annular fan exit area between said fan nacelle and said core nacelle.

9. A gas turbine engine comprising:
a core engine defined about an axis;
a gear system driven by said core engine;
a fan driven by said gear system about said axis;
a core nacelle defined at least partially about said core engine; and
a fan nacelle mounted around said fan and at least partially around said core nacelle, said fan nacelle having a fan variable area nozzle with a flexible adaptive segment which defines a fan exit area downstream of said fan between said fan nacelle and said core nacelle.

10. The engine as recited in claim 9, wherein said flexible adaptive segment morphs relative said fan nacelle.

11. The engine as recited in claim 9, wherein said flexible adaptive segment includes a trailing edge of said fan variable area nozzle.

12. A method of varying a fan exit area of a gas turbine engine comprising the steps of:
(A) locating a fan variable area nozzle to define a fan exit area between a fan nacelle and a core nacelle; and
(B) morphing a flexible adaptive segment of the fan variable area nozzle between a first shape and a second shape to vary the fan exit area.

13. A method as recited in claim 14, wherein said step (B) further comprises:
(a) increasing the fan exit area during takeoff.

14. A method as recited in claim 14, wherein said step (B) further comprises:
(a) flexing a flexible skin of the flexible adaptive segment.

15. A method as recited in claim 14, wherein said step (B) further comprises:
(a) deforming a flexible skin of the flexible adaptive segment.

16. A method as recited in claim 14, wherein said step (B) further comprises:
(a) changing a shape of the flexible adaptive segment.

17. A method as recited in claim 14, wherein said step (A) further comprises:
(a) locating the fan variable area nozzle an aft most section of the fan nacelle, the flexible adaptive segment including a trailing edge of the fan variable area nozzle.

18. A method as recited in claim 14, wherein said step (B) further comprises:
(a) asymmetrically adjusting the fan exit area to vector thrust through the fan variable area nozzle.
